(19) United States
(12) Patent Application Publication
(10) Pub. No.: US 2026/0051236 A1
(43) Pub. Date: Feb. 19, 2026

(54) GAIT MONITOR

(71) Applicant: Gentex Corporation, Zeeland, MI (US)

(72) Inventors: Thomas S. Wright, Hamilton, MI (US); Jeremy A. Schut, Grand Rapids, MI (US); Pujitha Mannaru, Wyoming, MI (US); Andrew D. Weller, Holland, MI (US); Eric P. Bigoness, Ada, MI (US); Vijay Vignesh Prasad Rao, Grand Rapids, MI (US); Jensen R. Holm, Allendale, MI (US)

(73) Assignee: Gentex Corporation, Zeeland, MI (US)

(21) Appl. No.: 19/297,263

(22) Filed: Aug. 12, 2025

Related U.S. Application Data
(60) Provisional application No. 63/682,888, filed on Aug. 14, 2024.

(51) Int. Cl. G08B 21/04; G08B 31/00

(52) U.S. Cl. CPC G08B 21/0438; G08B 21/043; G08B 31/00

(57) ABSTRACT

A system of monitoring an environment includes at least one sensor module. The at least one sensor module includes a housing, a power receiving module, a communication module, at least one sensor, and at least one imager module. The at least one sensor is configured to detect the presence of an occupant in the environment. The at least one imager module is configured to capture gait characteristics of the occupant triggered by the detected presence of the occupant from the at least one sensor. A control system is configured to characterize the gait characteristics of the occupant from a characterization list including at least healthy and abnormal, and, if the gait characteristics are characterized as abnormal, generate a notification.

### CROSS-REFERENCE TO RELATED APPLICATION

This application claims priority to and the benefit under 35 U.S. C. § 119(e) of U.S. Provisional Application No. 63/682,888, filed on Aug. 14, 2024, entitled “GAIT MONITOR,” the disclosure of which is hereby incorporated herein by reference in its entirety.

### FIELD OF THE DISCLOSURE

The present disclosure generally relates to a system including one or more modules around an environment that detect gait characteristics of an occupant.

### SUMMARY OF THE DISCLOSURE

According to an aspect of the present disclosure, a system of monitoring an environment includes at least one sensor module. The at least one sensor module includes a housing, a power receiving module, a communication module, at least one sensor, and at least one imager module. The at least one sensor is configured to detect the presence of an occupant in the environment. The at least one imager module is configured to capture gait characteristics of the occupant triggered by the detected presence of the occupant from the at least one sensor. A control system is configured to characterize the gait characteristics of the occupant from a characterization list including at least healthy and abnormal, and generate a notification if the gait characteristics are characterized as abnormal.

According to another aspect of the present disclosure, a gait characteristic monitoring system includes at least one sensor module having a housing, a power receiving module, a communication module, and at least one sensor configured to detect the presence of an occupant in the environment. The at least one sensor module further including at least one imager module configured to capture gait characteristics of the occupant triggered by the detected presence of the occupant from the at least one sensor. The at least one imager module is configured to capture the images with a shutter speed of at least 1/200. A control system is configured to characterize the gait characteristics of the occupant from a characterization list including at least healthy and abnormal, and generate a notification if the gait characteristics are characterized as abnormal.

According to yet another aspect of the present disclosure, a gait characteristic monitoring system includes at least one sensor module having a housing, a power receiving module, and at least one imager module configured to capture gait characteristics including at least one attribute of the stride of the occupant. A control system is configured to collect the detected gait characteristics over an extended period of time to develop a predictive model of the occupant, and generate the notification if the gait characteristics begin to change beyond a threshold of the predictive model of the occupant.

According to another aspect, a controller is configured to profile key points of at least one of hips, legs, knees, ankles, and feet of the occupant, detect at least one attribute of stride from a list including a stride rate, a stride length, a stride height, and a number of strides per period of time, and characterize gait characteristics of an occupant from a characterization list based on the at least one attribute of stride.

According to still another aspect, a control system is configured to collect at least one detected attribute of stride over an extended period of time to develop a predictive model of an occupant and generate the notification if the gait characteristics begin to change beyond a threshold of the predictive model of the occupant.

The present disclosure generally provides a system of monitoring gait characteristics of one or more occupants located in an environment. The system includes at least one sensor module that is capable of detecting characteristics of the occupant's gait. These detected characteristics can be utilized monitor the one or more occupants for deterioration or changes to their gait in order to maintain a safe environment for occupants.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1A is a top, plan view of a monitoring system within an environment, according to an aspect of the present disclosure;

FIG. 1B is an upper perspective view of the environment incorporating several sensor modules, according to an aspect of the present disclosure;

FIG. 1C is a time-lapse of an occupant's gait captured by an imager module, according to an aspect of the disclosure;

FIG. 2 is a schematic view of a plurality of sensor modules in communication with each other and a hub, according to an aspect of the present disclosure;

FIG. 3A is a front schematic view of a sensor module, according to an aspect of the present disclosure;

FIG. 3B is a front perspective view of a sensor module, according to an aspect of the present disclosure; and

FIG. 4 is a control system regulating activities of one or more sensor modules, according to an aspect of the present disclosure.

### DETAILED DESCRIPTION

The present illustrated embodiments reside primarily in combinations of method steps and apparatus components related to a system including one or more modules around an environment that detect gait characteristics of an occupant. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

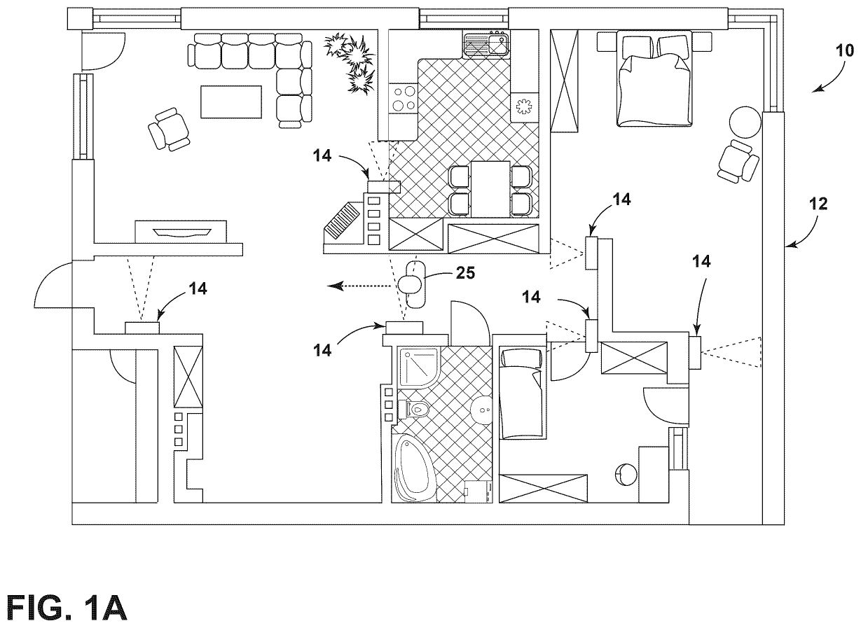

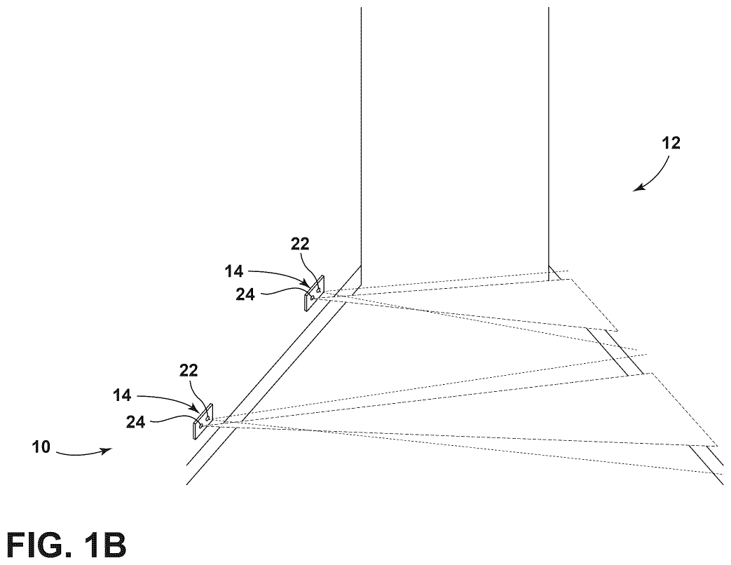

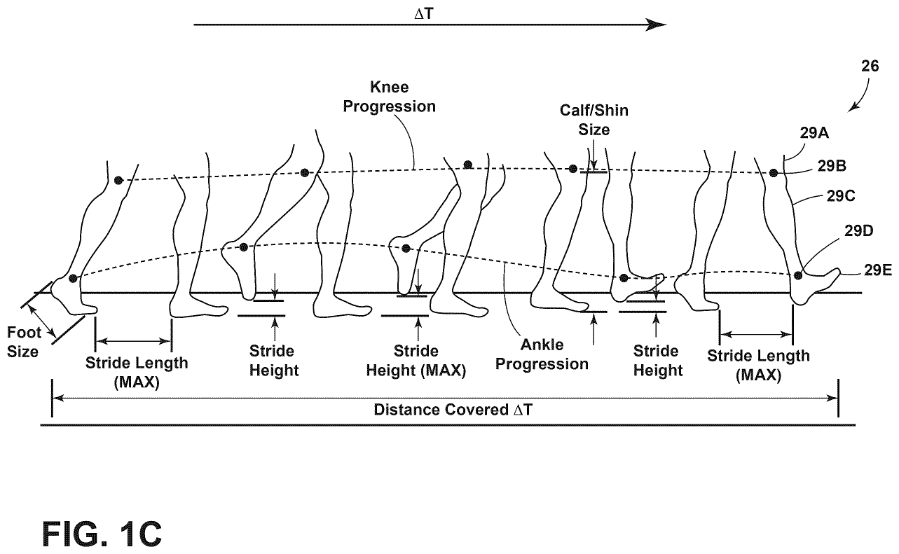

For purposes of description herein, the terms “upper,” “lower,” “right,” “left,” “rear,” “front,” “vertical,” “horizontal,” and derivatives thereof, shall relate to the disclosure as oriented in FIG. 1B. Unless stated otherwise, the term “front” shall refer to the surface of the device closer to an intended viewer of the device, and the term “rear” shall refer to the surface of the device further from the intended viewer of the device. However, it is to be understood that the disclosure may assume various alternative orientations, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

Referring initially to FIGS. 1A-3B, a system of monitoring an environment 12 or gait characteristics is designed by reference numeral 10. The system 10 includes at least one sensor module 14. The at least one sensor module 14 includes a housing 16, a power receiving module 18, a communication module 20, at least one sensor 22, and an imager module 24. The at least one sensor 22 is configured to detect the presence of an occupant 25 in the environment 12. The at least one imager module 24 is configured to capture gait characteristics of the occupant 25 triggered by the detected presence of the occupant 25 from the at least one sensor 22. A control system 100 is configured to characterize the gait characteristics of the occupant 25 from a characterization list including at least healthy and abnormal, and, if the gait characteristics are characterized as abnormal, generate a notification.

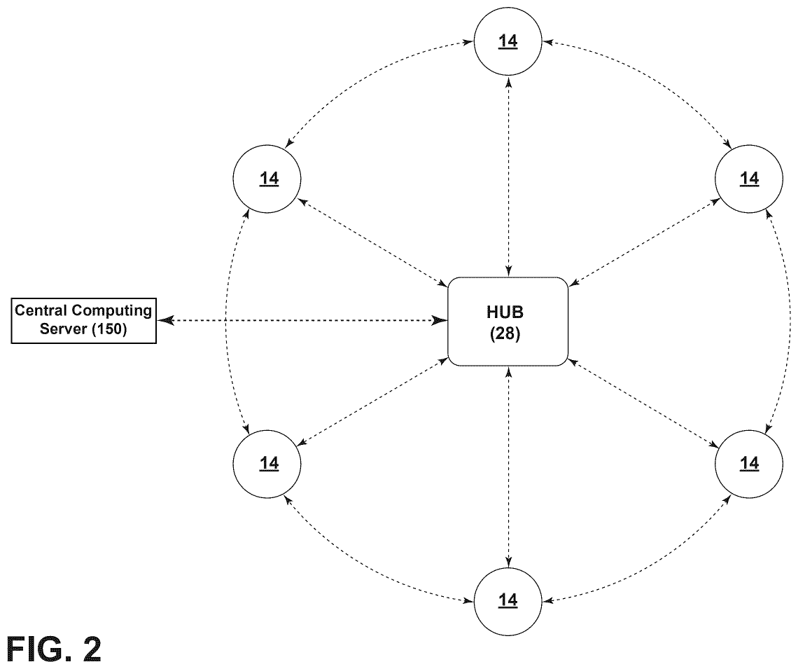

With continued reference to FIGS. 1A-3B, the system 10 detects and characterizes the occupant's 25 gait and changes to the occupant's 25 gait over a period of time within the environment 12. More particularly, the system 10 may generate notifications and/or make recommendations based on a single or repeated detected presence of the occupant 25 and subsequent capturing (i.e., with the at least one imager module 24) of the occupant's 25 gait. The at least one image module 24 may capture image data 26 of the occupant 25 as the occupant travels past the sensor module 14 and, over time, develop a predictive profile of the occupant's 25 gait and/or compare the occupant's 25 gait to at least one predefined model of a healthy or unhealthy (e.g., abnormal) gait. While accumulating data, if the occupant 25 exhibits a gait characterization that diverges from the predictive model or the predefined model (i.e., the gait is abnormal), then the control system 100 may be configured to generate the notification. More particularly, in home healthcare systems where the occupant 25 is monitored at home, in nursing homes, in medical environments, and in other environments, metric data gathering of gait characteristics can be monitored to help ensure health and continued mobility of the occupant 25. While the monitoring system 10 may be utilized in any type of environment 12 and for monitoring any type of occupant 24, the monitoring system 10 may be particularly beneficial for occupants with health conditions that need to be monitored. For example, occupants 24 who are disabled, elderly, or prone to risk or deteriorating health may be monitored for irregularities in gait that may be potentially hazardous to the occupant 24. In this manner, the monitoring system 10 may be utilized to monitor and track the occupant 24 in healthcare environments, assisted living environments, or to prolong independent living With reference now specifically to FIGS. 1A-2, the at least one sensor 22 may include a single or a plurality of sensors 22 (e.g., one, two, three, four, or more) and the at least one imager module 24 may include a single or a plurality of imager modules 24 (e.g., one, two, three, four, or more) located in the housing 16. Likewise, the at least one sensor module 14 may include a plurality of sensor modules 14 distributed around the environment 12, each sensor module 14 may include a single or a plurality of the sensors 22 and/or a single or a plurality of imager modules 24. Obtaining metric data, therefore, may be accomplished by, for example, a single sensor module 14 with a single sensor 22 and a single imager module 24, a single sensor module 14 with a plurality of sensors 22 and a plurality of imager modules 24, a single sensor module 14 with a plurality of sensors 22 and a single imager module 24, a single sensor module 14 with a single sensor and a plurality of imager modules 24, or a plurality of sensor modules 14 each with a single and/or a plurality sensors 22 and imager modules 24. When a plurality of the sensor modules 14 are utilized, each sensor module 14 may be in communication with one, more, or each of the other sensor modules 14 via the communication modules 20. Further, one, more, or each of the sensor modules 14 may be in communication with a hub 28 that receives and/or transmits the metric data from one, more, or each sensor modules 14.

The communication between components may be wireless, for example, via a Wi-Fi network, a cellular network, Bluetooth, NearLink, near-field communication (NFC), LPWAN, ultra-wideband (UWB) and IEEE 802.15. 4, other short-range communication network, the like, and/or combinations thereof. However, in other implementations, the communication between components may be wired and/or a combination of wired and wireless. As will be described in greater detail below, the control system 100 may include components in the one or more sensor modules 14, the hub 28, or combinations thereof.

With reference now to FIGS. 1B and 1C, the sensor modules 14 may be configured to attach close to a floor of the environment 12 (e.g., at or proximate wall outlets), such that the at least one imager module 24 captures (e.g., in image data 26) lower regions of the environment 12 that correspond to lower body portions of the occupant 25 (e.g., below the occupant's waist). More particularly, the at least one imager module 24 may be oriented with a vertical field-of-view (“FOV”) that captures lower portions of the occupant 25, for example, the hips and legs. More particularly, the at least one imager module 24 may capture thighs 29A, knees 29B, calves 29C, ankles 29D, and feet 29E of the occupant 25.

The lower portions of the occupant 25 may be profiled as key points when characterizing the occupant's 25 gait. For example, each of the waist, thighs 29A, knees 29B, calves 29C (or shins), ankles 29D, and feet 29E of the occupant 25 may be discerned and characterized as key points, including categorization of which leg the key points are associated with. By profiling the key points, various attributes of the occupant's gait can be characterized, such as stride rate, a stride length, a stride height, and/or a number of strides per period of time ΔT. In addition, various physical attributes of the occupant 25 can be collected, such as foot size, femur length (i.e., associated with a length of the thigh 29A), a length of the calf 29C or shin (e.g., between the knee 29B and ankle 29D), and/or ratios between these sizes. Further, other physical mechanisms can be collected, such as a maximum angle between the thigh 29A and the calf 29C or shin, a maximum angle between the foot 29E and the calf 29C or shin captured by the at least one imager module 24, and a maximum distance between like portions of both legs (e.g., indications of staggering). Each of these collected data points can be compared to the predictive profile of the occupant's 25 gait developed over time by the control system 100 and/or the at least one predefined model of a healthy or unhealthy (e.g., abnormal) gait pre-saved in the control system 100. In addition, each of these collected data points can be utilized by the control system 100 to identify the occupant 25. For example, in scenarios where multiple occupants are present, the collected data points may be saved and/or clustered as data. In this manner, once the presence of the occupant 25 is detected, the individualized identity of the occupant 25 from multiple different occupants can be determined. In this manner, predictive profiles may be developed for multiple occupants of the same environment 12.

The notification may be generated on the sensor modules 14, the hub 28, and/or any other device in communication with the system 10. For example, each sensor module 14 may include an alert module 30, such as an alert light, an audible element (e.g., a speaker), and/or the like that may be used to notify the occupant 25 when conditions are detected related to the occupant's 25 gait characteristics. The hub 28 may be local or remote to the environment 12 and may itself be configured to generate the notification (e.g., visually or audibly). In some embodiments, the hub 28 and/or sensor modules 14 may be in communication with a central computing server 150 that may be configured to generate the notification (e.g., visually or audibly). For example, the hub 28 and/or central computing server 150 may be associated with a remote caregiver service (e.g., in home health care), a facility service (e.g., a computing system at a nursing home or other medical environment), a mobile device (e.g., of the occupant 25 or a person responsible for monitoring the occupant 25). In this manner, the system 10 may provide notifications to the occupant 25 themselves and/or to caregivers that are local or remote from the environment 12.

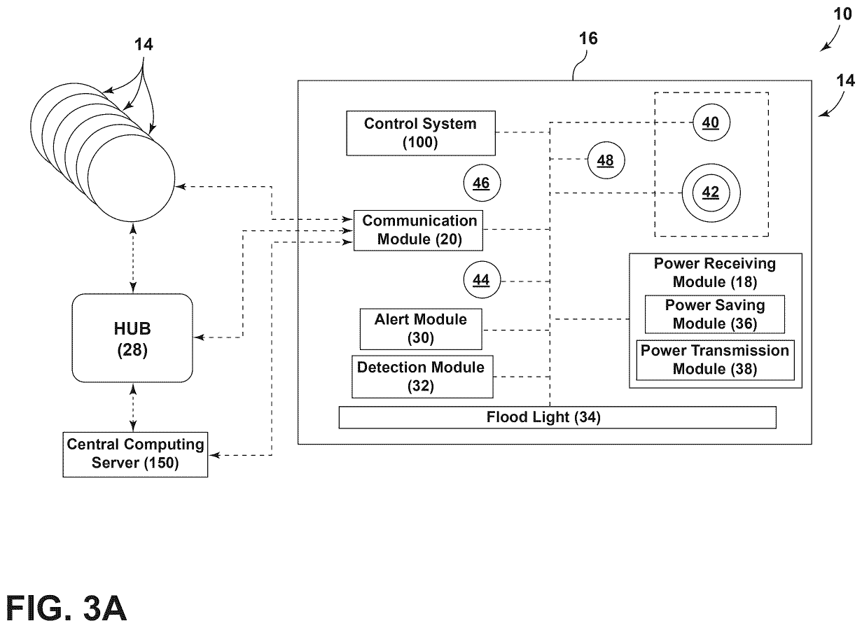

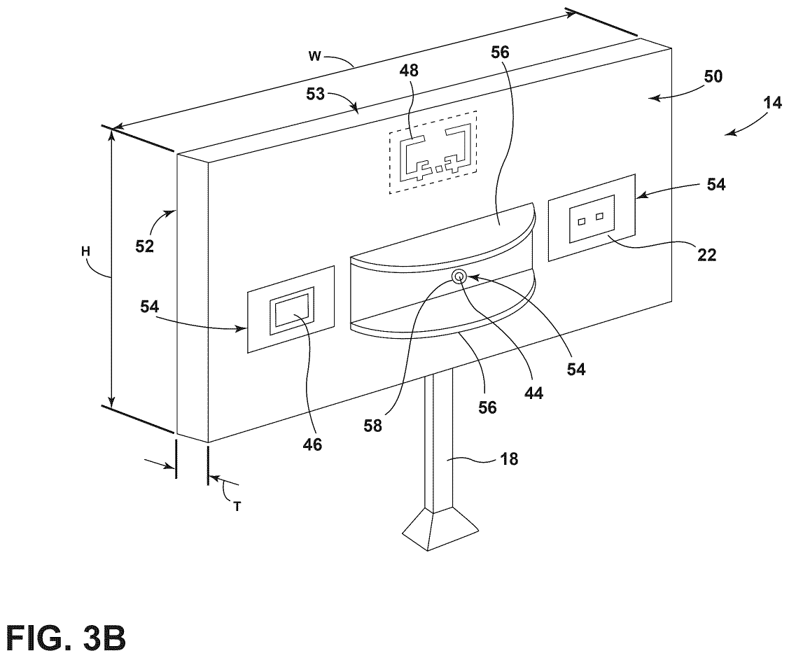

With reference now to FIGS. 3A and 3B, the sensor module 14 may include various components located within the housing 16. For example, the power receiving module 18, the communication module 20, the at least one sensor 22, the at least one imager module 24, and the alert module 30 may be located within the housing 16. In addition, the sensor module 14 may include a detector module 32 with one or more detectors each configured to detect one or more of the presence of the occupant 25, an ambient light level, and/or a power receiving status. The detection module 32 may be configured to trigger a flood light 34 that illuminates the environment when ambient light is below a threshold level and/or when the occupant 25 is in close proximity to the sensor module 14. The power receiving module 18 may include a direct current input, for example, for directly plugging into a wall outlet. The power receiving module 18 may further include a power saving module 36, for example, a battery charged by the direct current input. In this manner, in the event of a power outage, the sensor module 14 may continue to operate. In some embodiments, the detection module 32 may detect the power receiving status is off (i.e., that the sensor module 14 is not receiving power from the power receiving module 18) and switch the sensor module 14 to the power saving module 36. In some embodiments, the power receiving module 18 may include and/or be in operable communication with a power transmission module 38 (e.g., an outlet) for powering additional electronic devices through the power receiving module 18 and/or the power saving module 36.

With continued reference to FIG. 3A, the sensor 22 may be configured to operate under a variety of operational principles. For example, the sensor 22 may include a structured light source 40 and the imager module 24 may include a structured light imager module 42. The structured light source 40 may be configured to generate a structured light and the structured light imager module 42 may be configured to detect changes in the structured light (e.g., light spots reflected from the environment 12) for operation under the principles of Time-of-Flight (“ToF”). The principles of ToF may be particularly beneficial in some scenarios, as ToF sensors can be used to measure distances between the sensor module 14 and the lower portions of the occupant 25. In some embodiments, the sensor 22 is configured as a single pixel ToF sensor, such that the detection of the occupant 25 is a datum point from a single detectable change. In such embodiments, the structured light source 40 is configured to project a single illumination and the structured light imager module 42 is a single pixel structured light imager. In other embodiments, the ToF sensor may be configured as a multi-pixel sensor. In such embodiments, the structured light source 40 is configured to project a plurality of illuminations and the structured light imager module 42 is configured to detect changes in the plurality of illuminations. In this manner, the control system 100 is configured to utilize the detected changes to extract three-dimensional (“3D”) depth and size information. The 3D depth and size information may be beneficial in measuring the portions of the occupant's 25 lower body and measurements related to distances between the key points as the occupant 25 walks past the structured light imager module 42. More particularly, size information in conjunction with depth information can be extrapolated to determine the absolute scale and measurements of the occupant 25 and the occupant's gait. Further, when structured light is utilized, changes in speckle content of the one or more light spots or captured pixels thereof can be utilized (e.g., via the control system 100) to determine movements in the micrometer and/or microradian scale. The changes in speckle content may be associated with determining biometric information such as breath rates, heart rates, and/or the like. When one of the biometric readings are abnormal (e.g., outside of a threshold), the control system 100 may generate a notification as described above.

With continued reference to FIG. 3A, the at least one imager module 24 may include other configurations and/or additional imager modules 24 to capture other types of image data 26. For example, the at least one imager module 24 may alternatively or additionally to the structured light imager module 42, include a visual light imager module 44, a thermal imager module 46, a radar module 48 configured to convert received radar signals into digital data (e.g., image data 26), the like, and/or combinations thereof. In addition, the at least one imager module 24 may alternatively or additionally include a color imager, a near infrared imager, and/or a combination thereof. The control system 100 may, for example, be configured to profile the key points of the occupant 25 via the image data 26 received from the structured light imager module 42, the visual light imager module 44, the thermal imager module 46, and/or the radar module 48. By identifying a profile of the key points (e.g., the waist, thighs 29A, knees 29B, calves 29C (or shins), ankles 29D, and feet 29E of the occupant 25), the control system 100 may be further configured to extrapolate the various attributes and physical mechanisms of the occupant's 25 gait that have been previously described.

The system 10 (e.g., the control system 100) may be configured to, based on the detected presence of the occupant 25 via the at least one sensor 22, trigger the at least one imager module 24 to collect image data on the occupant 25. In some embodiments, if the presence is detected in one sensor module 14, the at least one imager module 14 associated with a proximate sensor module 14 may also be triggered. Further, the at least one sensor 22 may include two or more sensors 22 projecting in opposing angles from the sensor module 14, for example, the opposing angles may be greater than a width of the FOV of the at least one imager module 24. Regardless of the number of sensors 22, the width of the FOV or horizontal FOV of the at least one imager module 24 (e.g., a single, some, or each imager module implemented) may be at least 45°, for example, at least 60°, at least 70°, at least 80°, at least 90°, at least 100°, at least 120°, at least 130°, at least 140°, or at least 150°. In this manner, at least a full stride may be captured in the image data 26. The at least one imager module 24 (e.g., a single, some, or each imager module implemented) may include a shutter speed that is capable of making reliable identification and profiling of the key points, for example, by minimizing motion blur. The shutter speed may be at least 1/200, for example, at least 1/200, at least 1/500, at least 1/800, at least 1/1000, at least 1/1200, at least 1/1400, at least 1/1600, at least 1/1800, about 1/1820, or at least 1/2000.

In operation, when the occupant 25 is initially detected by the at least one sensor 22, the control system 100 may be configured to initiate a count that ends when the occupant 25 is past the horizontal FOV. In this manner, the time it takes for the occupant 25 to traverse the horizontal FOV can be utilized to determine the number of strides per period of time ΔT and, as a result, the occupant's 25 speed. Likewise, once the count has ended, a second count may be initiated when the occupant 25 is detected by a different sensor module 14. When multiple sensor modules 14 are utilized, and in communication with one another, the distance between the sensor modules 14 is determined (e.g., via the control system 100). Accordingly, metric data can be continually gathered based on the time difference and distance between proximate sensor modules 14.

With reference now to FIG. 3B, the housing 16 includes a front face 50 and a rear face 52 spaced from the front face 50 via a sidewall 53. The front face 50 may define a series of apertures 54 aligned with the at least one sensor 22 and the at least one imager module 24. The rear face 52 or a bottom sidewall 53 may define the connection for the power receiving module 18. The flood light 34 may be located proximate a bottom edge of the rear face 52 and oriented for illuminating, for example, the floor of the environment 12. The sidewall 53 defines a thickness T that is less than a width W and height H of the front and rear faces 50, 52. For example, the thickness T may be less than one or both of the width W and the height H by a factor of 2, 3, 4, 5, or more. In this manner, the sensor module 14 maintains a low profile against a wall of the environment 12. At least one of the imager modules 24 (e.g., the visual light imager module 44 or other configurations) may be located between a pair of ridges 56, a lens element 58 may be located between the ridges 56 and or within the aperture 54 associated with the visual light imager module 44.

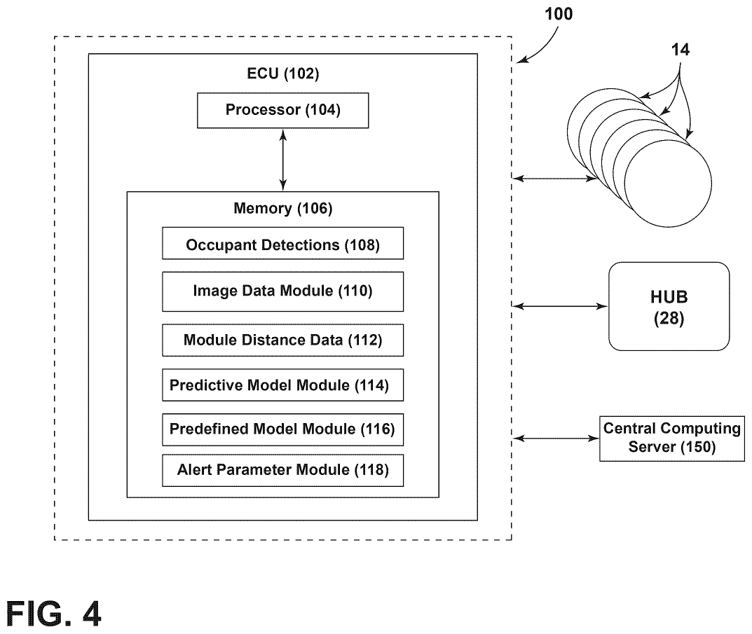

With reference now to FIG. 4, the control system 100 of the system 10 may include at least one electronic control unit (ECU) 102. The control system 100 (e.g., at least one ECU 102) may be located in the sensor module 14, the hub 28, the central computing server 150, and/or combinations thereof. In this manner, when the control system 100 performs some action, the instructions and/or actions may be from the sensor module 14, the hub 28, the central computing server 150, and/or combinations thereof. The at least one ECU 102 may include the processor 104 and a memory 106. The processor 104 may include any suitable processor and/or microprocessor. Additionally, or alternatively, each ECU 102 may include any suitable number of processors, in addition to or other than the processor 104. The memory 106 may comprise a single disk or a plurality of disks (e.g., hard drives) and includes a storage management module that manages one or more partitions within the memory 106. In some embodiments, memory 106 may include flash memory, semiconductor (solid state) memory, or the like. The memory 106 may include Random Access Memory (RAM), a Read-Only Memory (ROM), Electrically Erasable Programmable Read-Only Memory (EEPROM), or a combination thereof. In some embodiments, an EPS32 micro-controller is utilized, with, for example, a built-in universal asynchronous receiver/transmitter (“UART”) may be associated with the communication module 20 for Wi-Fi and Bluetooth connectivity and the communication modules 20 may be configured for an ESP-NOW wireless communication protocol. The memory 106 may include instructions that, when executed by the processor 104, cause the processor 104 to, at least, perform the functions associated with the components of the system 10. The various components of the system 10 may, therefore, be controlled by the control system 100. The memory 106 may, therefore, include a series of occupant detections 108, an image data module 110 (e.g., captured image data 26), module distance data 112 (e.g., distances between two or more of the sensor modules 14), a predictive model module 114, a predefined model module 116, and an alert parameter module 118.

The series of occupant detections 108 may include a series of detections of the occupant associated with which sensor module 14 has detected the occupant 25 and when the occupant 25 was detected. The image data module 110 may include the captured image data 26 from the at least one imager module 24. The module distance data 112 may include distances between two or more of the sensor modules 14, which, in combination with the series of occupant detections 108 can be used to extrapolate activities of the occupant 25. In some embodiments, the series of occupant detections 108 and the image data 26 (i.e., in the image data module 110) may be periodically overwritten as information is extrapolated into metric data. More particularly, the predictive model module 114 may include extrapolations of image data 26 of the occupant 25 as the occupant travels past the sensor module 14 over time to develop a predictive profile of the occupant's 25 gait (e.g., including physical attributes), which can be standardized as metric data and compared to the occupant's gait over subsequent traveling. The predictive model module 114 may be developed overtime by averaging one or more of the above defined walking attributes described in reference to FIG. 1C and comparing those attributes individually or in a meta comparison. Further, in some implementations, a machine learning protocol may be utilized to determine the predictive model module 114. When the occupant's 25 gait, for example, begins to diverge from the predictive profile (e.g., a change or decrease of stride rate, a stride length, a stride height, a number of strides per period of time ΔT, and/or changes to the physical mechanisms), the notification can be generated. The predefined model module 116 may include one or more pre-saved, predefined models of healthy gaits that can be compared to the image data 26 and/or the predictive models. The one or more predefined models may include classifications related to the physical attributes of the occupant 25, for example, foot size, femur length (i.e., associated with a length of the thigh 29A), a length of the calf 29C or shin (e.g., between the knee 29B and ankle 29D). The control system 100 may select which predefined model is utilized based on similarities between the physical attributes of the predefined models and the occupant 25. The alert parameter module 118 may include threshold information on when to generate the notification or alert. For example, the alert parameter module 118 may include protocols for establishing thresholds of divergence of the occupant's 25 gait and the predictive or predefined models, for example, how abnormal the occupant's gait is before generating the notification or alert.

The disclosure herein is further summarized in the following paragraphs and is further characterized by combinations of any and all of the various aspects described therein.

According to one aspect of the present disclosure, system of monitoring an environment includes at least one sensor module. The at least one sensor module includes a housing, a power receiving module, a communication module, at least one sensor, and at least one imager module. The at least one sensor is configured to detect the presence of an occupant in the environment. The at least one imager module is configured to capture gait characteristics of the occupant triggered by the detected presence of the occupant from the at least one sensor. A control system is configured to characterize the gait characteristics of the occupant from a characterization list including at least healthy and abnormal, and, if the gait characteristics are characterized as abnormal, generate a notification.

According to yet another aspect, at least one sensor includes a motion detector.

According to still another aspect, at least one sensor includes a structured light source and the at least one imager module includes a structured light imager configured to operate under the principles of time of flight.

According to another aspect, the structured light source is configured to project a single illumination and the structured light imager is a single pixel structured light imager.

According to still another aspect, the control system is configured to review speckle content from data captured from the single pixel structured light imager for movement in a microradian scale.

According to yet another aspect, the structured light source is configured to project a plurality of illuminations and the structured light imager is configured to detect changes in the plurality of illuminations, the control system is configured to utilize the detected changes to extract three-dimensional (“3D”) depth information.

According to still another aspect, at least one imager module includes a visual light imager module.

According to yet another aspect, at least one imager module includes a thermal imager module.

According to still another aspect, a system includes a radar module configured to convert received radar signals into digital data.

According to yet another aspect, a controller is configured to profile key points of at least one of hips, legs, knees, ankles, and feet of the occupant, detect at least one attribute of stride from a list including a stride rate, a stride length, a stride height, and a number of strides per period of time, and characterize gait characteristics of an occupant from a characterization list based on the at least one attribute of stride.

According to still another aspect, a system includes a control system for comparing at least one attribute of stride with predefined models.

According to another aspect, a control system is configured to collect at least one detected attribute of stride over an extended period of time to develop a predictive model of an occupant, and generate the notification if the gait characteristics begin to change beyond a threshold of the predictive model of the occupant.

According to yet another aspect, a characterization list includes a plurality of rating scores between healthy and abnormal.

According to still another aspect, at least one imager module is configured to capture the images with a shutter speed of at least 1/200.

According to yet another aspect, at least one imager module is configured to capture the images with a shutter speed of at least 1/1000.

According to still another aspect, at least one imager module has a horizontal field of view of at least 100°.

According to another aspect of the present disclosure, a gait characteristic monitoring system includes at least one sensor module having a housing, a power receiving module, a communication module, and at least one sensor configured to detect the presence of an occupant in the environment. The at least one sensor module further including at least one imager module configured to capture gait characteristics of the occupant triggered by the detected presence of the occupant from the at least one sensor. The at least one imager module is configured to capture the images with a shutter speed of at least 1/200. A control system is configured to characterize the gait characteristics of the occupant from a characterization list including at least healthy and abnormal, and generate a notification if the gait characteristics are characterized as abnormal.

According to another aspect, the shutter speed is at least 1/1000.

According to yet another aspect, the at least one imager module has a horizontal field of view of at least 100°.

According to yet another aspect of the present disclosure, a gait characteristic monitoring system includes at least one sensor module having a housing, a power receiving module, and at least one imager module configured to capture gait characteristics including at least one attribute of stride of the occupant. A control system is configured to collect the detected gait characteristics over an extended period of time to develop a predictive model of the occupant, and generate the notification if the gait characteristics begin to change beyond a threshold of the predictive model of the occupant.

According to another aspect, a gait characteristic monitoring system including a control system that is configured to profile key points of at least one of hips, legs, knees, ankles, and feet of the occupant, detect the at least one attribute of stride from a list including a stride rate, a stride length, a stride height, and a number of strides per period of time, and develop the predictive model of the occupant based on the at least one attribute of stride.

According to yet another aspect, a gait characteristic monitoring system including a control system that is configured to detect at least one physical attribute of the occupant related to a size of a portion of the occupant's leg or ratio between a size of two portion of the occupant's leg, and identify the occupant from a plurality of occupants based on the at least one physical attribute.

According to still another aspect, a gait characteristic monitoring system including a control system that is configured to profile key points of an occupant's legs including at least one of a thigh, a shin, or a foot, detect the at least one attribute of stride from a list including a maximum angle between the thigh and the shin, a maximum angle between the foot and the shin, or a maximum distance between like portions of both legs, and develop the predictive model of the occupant based on the at least one attribute of stride.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connectors or other elements of the system may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further it is to be understood that such concepts are intended to be covered by the following claims unless these claims by their language expressly state otherwise.

What is claimed is:

1. A gait characteristic monitoring system comprising:
at least one sensor module, comprising:
a housing;
a power receiving module;
a communication module;
at least one sensor configured to detect the presence of an occupant in the environment;
at least one imager module configured to capture gait characteristics of the occupant triggered by the detected presence of the occupant from the at least one sensor; and
a control system configured to:
characterize the gait characteristics of the occupant from a characterization list including at least healthy and abnormal; and
generate a notification if the gait characteristics are characterized as abnormal.

2. The gait characteristic monitoring system of claim 1, wherein the at least one sensor includes a motion detector.

3. The gait characteristic monitoring system of claim 1, wherein the at least one sensor includes a structured light source and the at least one imager module includes a structured light imager configured to operate under the principles of time of flight.

4. The gait characteristic monitoring system of claim 3, wherein the structured light source is configured to project a single illumination and the structured light imager is a single pixel structured light imager.

5. The gait characteristic monitoring system of claim 4, wherein the control system is configured to review speckle content from data captured from the single pixel structured light imager for movement in a microradian scale.

6. The gait characteristic monitoring system of claim 3, wherein the structured light source is configured to project a plurality of illuminations and the structured light imager is configured to detect changes in the plurality of illuminations, the control system configured to utilize the detected changes to extract three-dimensional (“3D”) depth information.

7. The gait characteristic monitoring system of claim 1, wherein the at least one imager module includes a visual light imager module.

8. The gait characteristic monitoring system of claim 1, wherein the at least one imager module includes a thermal imager module.

9. The gait characteristic monitoring system of claim 1, further including a radar module configured to convert received radar signals into digital data.

10. The gait characteristic monitoring system of claim 1, wherein the control system is further configured to:
profile key points of at least one of hips, legs, knees, ankles, and feet of the occupant;
detect at least one attribute of stride from a list including a stride rate, a stride length, a stride height, and a number of strides per period of time; and
characterize the gait characteristics of the occupant from the characterization list based on the at least one attribute of stride.

11. The gait characteristic monitoring system of claim 10, further including comparing the at least one attribute of stride with predefined models.

12. The gait characteristic monitoring system of claim 10, wherein the control system is further configured to:
collect the detected at least one attribute of stride over an extended period of time to develop a predictive model of the occupant; and
generate the notification if the gait characteristics begin to change beyond a threshold of the predictive model of the occupant.

13. The gait characteristic monitoring system of claim 1, wherein the characterization list includes a plurality of rating scores between healthy and abnormal.

14. A gait characteristic monitoring system comprising:
at least one sensor module, comprising:
a housing;
a power receiving module;
a communication module;
at least one sensor configured to detect the presence of an occupant in the environment;
at least one imager module configured to capture gait characteristics of the occupant triggered by the detected presence of the occupant from the at least one sensor, the at least one imager module is configured to capture the images with a shutter speed of at least 1/200; and
a control system configured to:
characterize the gait characteristics of the occupant from a characterization list including at least healthy and abnormal; and
generate a notification if the gait characteristics are characterized as abnormal.

15. The gait characteristic monitoring system of claim 14, wherein the shutter speed is at least 1/1000.

16. The gait characteristic monitoring system of claim 14, wherein the at least one imager module has a horizontal field of view of at least 100°.

17. A gait characteristic monitoring system comprising:
at least one sensor module, comprising:
a housing;
a power receiving module;
at least one imager module configured to capture gait characteristics including at least one attribute of stride of the occupant; and
a control system configured to:
collect the detected gait characteristics over an extended period of time to develop a predictive model of the occupant; and
generate the notification if the gait characteristics begin to change beyond a threshold of the predictive model of the occupant.

18. The gait characteristic monitoring system of claim 17, wherein the control system is further configured to:
profile key points of at least one of hips, legs, knees, ankles, and feet of the occupant;
detect the at least one attribute of stride from a list including a stride rate, a stride length, a stride height, and a number of strides per period of time; and
develop the predictive model of the occupant based on the at least one attribute of stride.

19. The gait characteristic monitoring system of claim 17, wherein the control system is further configured to:
detect at least one physical attribute of the occupant related to a size of a portion of the occupant's leg or ratio between a size of two portion of the occupant's leg;
identify the occupant from a plurality of occupants based on the at least one physical attribute.

20. The gait characteristic monitoring system of claim 17, wherein the control system is further configured to:
profile key points of an occupant's legs including at least one of a thigh, a shin, or a foot;
detect the at least one attribute of stride from a list including a maximum angle between the thigh and the shin, a maximum angle between the foot and the shin, or a maximum distance between like portions of both legs; and
develop the predictive model of the occupant based on the at least one attribute of stride.
